(19) United States
(12) Patent Application Publication
(10) Pub. No.: US 2006/0253794 A1
(43) Pub. Date: Nov. 9, 2006

(54) Internet-Based Affinity Marketing Method Including a Desktop Customizable Toolbar

(76) Inventor: David R. Wilson, Southborough, MA (US)

Correspondence Address: MIRICK, O'CONNELL, DEMALLIE & LOUGEE, 100 FRONT STREET, WORCESTER, MA, 01608, US

(21) Appl. No.: 11/381,148

(22) Filed: May 2, 2006

Related U.S. Application Data
(60) Provisional application No. 60/677,280, filed on May 3, 2005.

(51) Int. Cl. G06F 17/00

(52) U.S. Cl. 715/779

(57) ABSTRACT

A method of providing a marketing portal presented in the form of a user and third-party customizable toolbar that is displayable on the desktop of a user's computer, in which the user's computer is electronically coupled to a third-party's computer. The method creates on the user's desktop a toolbar that defines a number of separate functional areas. The functional areas include at least a third-party content area, an Internet library area, a computer applications area, and a toolbar configuration area. Typically, one or more toolbar display skins are also stored and selectable through the toolbar functional area. A number of third-party messages are stored in the user's computer; each such message typically contains at least an image, and may contain text. The text can be streamed. The third-party messages are sequentially displayed in the toolbar third-party content area. One or more links to web sites are provided in the Internet library area; the user can modify some or all of such links. A number of links to application programs accessible by the user's computer are provided in the computer application area. A number of separate function-specific, user-operable buttons are provided in the toolbar configuration area; the function associated with at least one such button is typically fixed, and the function associated with at least one other such button is typically user-assignable.

### CROSS-REFERENCE TO RELATED APPLICATION

This application claims priority of Provisional application Ser. No. 60/677,280, with a filing date of May 3, 2005.

### FIELD OF THE INVENTION

This invention relates to an internet-based affinity marketing method including a desktop customizable toolbar.

### BACKGROUND OF THE INVENTION

Interactively communicating selectively targeted information with consumers over the internet is known, for example as disclosed in US patent application publication number US 2004/0204988, by Willers et al. Willers et al. disclose a client/server system that employs special server software, creates a special virtual network, and stores user-related customized information on the server. These aspects drive up the cost and complexity of the system, and inherently limit its applications. There is a need for a simple, user-customizable desktop toolbar that comprises the user end of an affinity marketing method.

### SUMMARY OF THE INVENTION

“Affinity Groups” are groups of individuals that share a close connection marked by a community of interests or similarity in nature or character. “Sponsors” are organizations that have formal or informal “affinity groups”, a website and a desire to strengthen the relationship they have with the members of their “affinity group(s)”. Examples of potential “sponsors” include: colleges and universities, collegiate, professional and national sports teams, fraternal organizations, religious organizations, non-profit organizations, special interest groups, professional organizations, alumni organizations, fan clubs, political campaigns, motorcycle clubs, ski mountains, etc., as well as all traditional commercial enterprises that use the internet to advertise or market their goods and services. “Sponsors” are desirous of strengthening the relationships they have with their “affinity groups” in order to advertise their products, solicit donations, sell products over the internet, recruit new members, etc.

The invention accomplishes a marketing method, and comprises a computer software program that creates a marketing portal on the user's computer screen displayed in the form of a toolbar, and a toolbar management software system that “sponsors” can use as a communications platform to create or strengthen their connections with “affinity group” members, irrespective of whether or not the user is connected to the internet. For “sponsors”, the communications medium is typically the internet. The communications medium can alternatively comprise a private network. The toolbar provides for the user both continuing, refreshed contact with one or more “sponsors”, as well as a desktop location from which the user can work. The functionality of the toolbar increases the likelihood of its use, thus increasing the amount of time in which the user is exposed to the sponsor(s)” messages.

This invention features a method for storing an inventory of “sponsor” content, such as digital images, audio files, pictures, forms, captions, and streaming text, etc., on a user's hard drive to be displayed on the user's computer when no connection to the internet or a private network is open. Distribution of such “sponsor” content to the user can be accomplished via the internet or through various types of media such as CD, DVD, floppy disks, etc.

This invention features a method of providing a user a customizable toolbar that is displayable on the desktop of a user's computer, in which the user's computer is electronically coupled to a “sponsor's” or third-party's computer. In one embodiment the inventive method comprises creating on the user's desktop a toolbar that defines a number of separate functional areas, the functional areas comprising at least a third-party content area, an “internet library” area, a computer applications area, and a toolbar configuration area. Upon program installation a plurality of “sponsor” messages-are stored in the user's computer, each message comprising at least an image. The “sponsor” messages are sequentially displayed in the toolbar “sponsor” content area. The “internet library” area is provided with one or more links to web sites. The user can modify some such links. The computer application area is provided with a plurality of links to application programs accessible by the user's computer. A plurality of separate function-specific, user-operable buttons are provided in the toolbar configuration area and elsewhere on the toolbar. The function associated with at least one, and preferably at least two such buttons are fixed, and the function associated with at least one other such button is user-assignable.

The “sponsor” and the computers can be linked over the internet. The “sponsor” and the computers can be linked by a private network. The toolbar can further define a “sponsor” window and an advertising carousel window. The “sponsor” content area can also include a streaming text window, in which case “sponsor” messages stored by the program on the user's computer can also include text associated with the images, the text at least in part displayed in the streaming text window.

The stored third-party messages may also include text associated with the images, the text at least in part displayed in the third-party content area. The toolbar may further define a user-operable volume control function, and a user-operable hibernation control that allows the user to minimize the toolbar. The toolbar may still further define a toolbar display skin. A number of such skins may be stored in the user's computer. One of the function-specific, user-operable buttons in the toolbar configuration area can provide user control over the displayed toolbar skin.

An objective of the present invention is also to provide a method of utilizing the marketing method, software program, and toolbar management system for the purpose of improving a corporate sponsor's internal communications, while providing its employees, with the user benefits of the inventive toolbar. In this embodiment, an inventory of digital content, such as press releases, corporate forms, internal employee communications, etc. would be created and stored on a user's hard drive or served up by the “sponsor's” internal server.

Another objective of the present invention is to provide a method of integrating the internet marketing method, software program, and toolbar management system into a software or hardware vendor's product offering for the purpose of improving such vendors' communications with their customers or licensees, while providing their customers or licensees with the user benefits of the inventive toolbar. In this embodiment, an inventory of digital content, such as press releases, corporate forms, user manuals, etc. would be created and stored on a user's hard drive or served up by the vendor's internal server.

### Internet Marketing Method

The internet marketing method described herein enables a “sponsor” to deliver marketing information in a persistent manner to internet-enabled “affinity group” members, irrespective of whether or not an internet connection is open on the user's computer. This is accomplished by including an inventory of “sponsor” provided digital marketing information in a client-side toolbar software program. When the toolbar software program is installed, this inventory of marketing information is stored on the user's hard drive. When no internet connection is present, the toolbar displays the marketing information stored on the hard drive. When an internet connection is opened, the toolbar can display fresh marketing information that is pushed down to the user's toolbar by the “sponsor's” web server.

“Sponsors” can use this internet marketing method for a large variety of purposes such as: announcing promotions, recruiting new members, conducting electronic commerce, creating new product awareness, soliciting donations, communicating updated product information, building and managing customer relationships, increasing brand equity, etc.

### Toolbar Software Program

The inventive toolbar software program provides a novel means for a “sponsor” to put its marketing message in front of “affinity group” members in an environment that provides the “sponsor” with multiple opportunities to positively influence the member's actions as a result of the on-going interaction between the user and the toolbar. From a “sponsor's” perspective, the major benefits derived from using the inventive software are: it strengthens the bond between the “sponsor” and its “affinity group” members; it dramatically increases the likelihood that users will click-through to the “sponsor's” website; it increases the amount of time users spend at the “sponsor's” website; it dramatically increases the number of impressions a user sees of the “sponsor's” logo and other branding information; and, it is an extension of a “sponsor's” marketing activities that seamlessly supports the investments the “sponsor” has made in its marketing programs and websites. Additionally, when served up by the “sponsor's” web server, the toolbar displays updated offers, information, promotions, news, etc., ensuring that the “sponsor's” message always stays fresh. A further benefit for “sponsors” that conduct electronic commerce over the internet is that they can expect sales to increase because the software makes it so easy for users to connect, and stay connected to the “sponsor's” website, while the user is presented with current promotions, related product offerings, etc., thereby increasing the likelihood of the viewer making an impulse purchase.

For users, the software's toolbar display serves as a novel means to stay connected to “sponsors” they feel a strong association with, such as their favorite collegiate, professional and national sports teams. The toolbars also provide users with increased efficiency in terms of internet research, improved access to their favorite applications and websites, as well as enhanced control over their desktop environments, including the ability to customize them to make them more useful and personally meaningful, as well as more interesting looking.

The software's toolbar display consists of a number of components that provide users with a multi-sensory computing experience. These components include a “Content Carousel”, an “Internet Library”, an “Application Hotel”, and an “Advertising Carousel”, as well a number of different utility applets and program controls. Each “sponsor's” toolbar program also typically includes a number of a “personality modules” which include “skins” with different aesthetic qualities that relate to the identification of a “sponsor” that is of personal interest to the user. The “personality modules” also control functions which are unique to the particular personality, such as printing a coupon or rebate form displayed in the Content Carousel.

### BRIEF DESCRIPTION OF THE DRAWING

The FIGURE is a drawing of the preferred form of the inventive marketing portal presented in the form of a toolbar, which is typically located vertically along the right or left side of the user's computer display device.

### DESCRIPTION OF THE PREFERRED EMBODIMENT

The product features in the preferred embodiment of the software program include (see the attached FIGURE for a drawing of the preferred form of the inventive marketing portal presented in the form of a toolbar, which is typically located vertically along the right or left side of the display):

Autohide/Always-on-Top

The toolbar can be configured to stay “on top” so that it is always visible on the user's desktop, even when there is an application open, i.e., a word processor or spreadsheet program; alternatively, it can be placed, in “autohide” mode, so the toolbar is hidden when the user prefers to work in full screen mode. In “autohide”, the toolbar remains hidden until the user moves the cursor over a “hotspot”. When the cursor hits it, the toolbar instantly appears and remains on the screen until the cursor is moved back to the application workspace. When the toolbar is in “always on top” mode with an application open, the application is resized so that it occupies the remaining screen area. The advantage of working in “autohide” is the user does not have to give up a portion of the application desktop workspace but still has easy access to the toolbar's functionality. The inventive toolbars increase user efficiency because a number of mouse clicks related to various operations are eliminated, so time is saved. Of primary importance to the “sponsor”, regardless of the toolbar's display mode, is the fact that the user is persistently exposed to the “sponsor's” marketing information. In “autohide”, each renewal impression reinforces the “sponsor's” message; in “always on top” mode the “sponsor's” logo, branding and marketing information is a part of the user's desktop. In either case, exposure to the “sponsor's” information occurs regardless of whether or not the user is connected to the internet. Thus, the software persistently displays the “sponsor's” message whenever the user operates his or her computer.

Content Carousel

At the top of the toolbar there is a “Content Carousel” that displays marketing information. As a part of the toolbar installation procedure a collection of “sponsor”-provided digital images, audio files, pictures, forms, captions, and streaming text, etc., is copied to the user's hard drive. When the user is not connected to the internet, these images are displayed in the upper panel of the Content Carousel, while the streaming text is displayed in the lower panel. Captions can rotate synchronously with the associated image. If an internet connection is open, the Content Carousel rotates images and streaming text downloaded by the “sponsor's” web server. The Content Carousel feature is particularly appealing to “sponsors” because it lets them provide “affinity group” members with constantly updated offers, information, promotions, news, etc., ensuring that the “sponsor's” message always stays fresh. In addition, the Content Carousel scamlessly supports the significant investments “sponsors” have made, or plan to make, in their marketing campaigns and websites and increases their return-on-investment on these expenditures.

Internet Library

A section of the toolbar contains an “Internet Library” which lets users quickly and easily access their favorite websites and perform internet searches. Each time the toolbar is opened, it creates a link in the first panel of the Internet Library to the Favorites folder that is a part of the user's operating system. When the user mouse clicks this panel, a Favorites folder appears without the user having to open the computer's internet browser. This is a significant time-saver because the user is freed from having to minimize the application he or she is working in, opening an internet browser, opening the Favorites folder and then clicking through to the desired website. The toolbar has been optimized to work with the most popular browsers in use today; including Internet Explorer, Netscape, Mozilla, Opera and Firefox.

The second panel in the Internet Library contains a search window that includes a series of different search engines that the user can access. When the toolbar is installed, a number of sponsor-selected search engines, such as Google, Yahoo, and MSN Search, are included with the software but the user can easily add more later. A dropdown menu displays the list of available search engines for selection by the user. When the user enters text in the search window and presses the enter key, the search is initiated directly from the toolbar. This is a significant time-saver because the user is freed from having to minimize the application he or she is working in, opening the internet browser, entering the text into the browser's search window and then mouse clicking to initiate the search.

The third panel in the Internet Library contains a library carrel (“Workspace”) that can be populated with links to sites that are of immediate interest to the user. This is accomplished by dragging a website's URL from the internet browser's address box onto the panel. The user is then prompted to give the link a user-friendly name. Clicking on the panel opens a dropdown menu that displays the links stored in the carrel. Clicking on a link takes the user directly to that website. The user also has the option of creating project folders to store relevant links. This is useful because users doing project research on the internet can store URLs in the Workspace for future reference. When a URL or project folder is no longer needed it can be removed from the Workspace by right-clicking the panel and deleting the link from the dropdown menu. At the “sponsor's” option, in lieu of the Workspace, the third panel can be hard-coded with a URL designated by the “sponsor” which, when clicked, will take the user to the relevant website.

The fourth panel of the Internet Library contains a hard-coded link to a URL designated by the “sponsor” which, when clicked, will take the user to the relevant website. This is a significant time-saver because the user is freed from having to minimize the application he or she is working in, opening to the home page of the internet browser and (i) opening the Favorites folder if it contains a link to the “sponsor's” website, or (ii) if known, entering the URL in the browser's address box, or (iii) conducting a search to find it, and then clicking through to the desired website. From the “sponsor's” perspective, having this link on the desktop makes it so easy to complete the connection that it dramatically increases the probability that the user will do so to obtain more information, respond to the sponsor's advertising, purchase a product, complete a form, react to a promotion, etc.

Application Hotel

A section of the toolbar contains an “Application Hotel” panel that provides users with easy access to the applications they use most frequently. There are several ways of populating the hotel with applications. When the toolbar is first installed, the program scans the operating system's program file list for file extensions such as doc, xls, lwl, qbk, qdi, job, dbx, html, ppt, pdf, mp3, etc. If any are present, shortcuts for the default applications used by the system to open these file types are created and sent to the Application Hotel. Program order is determined from an array of today's most popular programs, arbitrarily ranked in order of presumed popularity. Shortcuts for up to eight applications are assigned to the control buttons located in the Application Hotel. If the user's computer has less than eight programs from the array, the program will link the remaining buttons to the operating system's utility programs, also arbitrarily ranked in order of presumed popularity, such as Windows Media Player, CD Player, Paint, etc. After program assignment, the program buttons have the associated icons assigned to them. Later, if a change to the order or mix of applications is desired, the user can drag and drop a short cut from the desktop, startup toolbar, start menu program folder or quicklaunch bar to one of the control buttons, thereby, updating it. The user can also drag and drop a file such as a spreadsheet or word processing document to a program button. Hovering over an icon causes a textbox containing the name of the respective application or file to appear.

Examples of applications a user might want to have in the Application Hotel include: Word, Excel, AOL Instant Messenger, Outlook Express, iTunes, Powerpoint, Palm Desktop, or a favorite computer game.

Advertising Carousel

A section of the toolbar contains an “Advertising Carousel” that can rotate advertisements or images at timed intervals. As a part of the toolbar installation procedure a collection of “sponsor”-provided advertisements or digital images is copied to the user's hard drive. When the user is not connected to the internet, these advertisements or images will be displayed in the Advertising Carousel. If an internet connection is open, the Advertising Carousel rotates advertisements or images that can be served up by an ad server. The invention's Advertising Carousel is a compelling feature for “sponsors” because it lets them provide “affinity group” members with constantly updated information, thereby ensuring that the “sponsor's” advertising message always stays fresh. At the “sponsor's” option, advertisements or images in the Advertising Carousel can be linked to URLs which, when clicked, take the user to websites where the user can obtain more information, submit a purchase order, made a donation, etc. “Sponsors” can also use the Advertising Carousel to display advertisements of affiliate advertising partners that are linked to their websites.

Personality Carousel

A key feature of the toolbar is that it gives the user the ability to change the toolbar's “personality” with the click of a button, thereby changing its “look and feel” and utility. Each toolbar typically includes a series of “personality modules” that have “skins” with different aesthetic qualities that relate to the identification of the “affinity group”, such as a collegiate, professional or national sports team that is of personal interest to the user. At the “sponsor's” option, each “personality module” can provide users with exposure to different branding information, different advertising messages, links to different web pages, etc. The “personality modules” can also control functions that are unique to the particular personality, such as printing a coupon or rebate form displayed in the Content Carousel. By using a series of different “personality modules” “sponsors” are able to deliver their marketing messages in a controlled fashion that positively influences the user to pursue a desired course of action. The “sponsor” can if desired control the messaging for the “personality modules”, and automatically rotate through the “sponsors” various “personality modules” in an order and for particular display times set by the sponsor”. These features accomplish more “sponsor” control over the marketing message. Alternatively, the “sponsor” can opt to allow the user the ability to control the order and timing of the rotation of the “personality modules.”

Configuration Dashboard

The toolbar has a configuration dashboard. It consists of four control buttons that lets the user control various toolbar actions. Hovering over a button opens a textbox that describes the action. When the toolbar is installed, the default actions for these buttons are:
First button—left-clicking toggles the toolbar between “always-on-top” and “autohide”.
Second button—controls the Personality Carousel. Left-clicking advances the carousel and displays the next available “personality module”. Right-clicking displays a set of radio buttons with a series of rotation times that can be selected by the user. Rotation order can be serial or random.
Third button—opens a utility program such as Windows' WordPad to make it easy for the user to enter and organize information gathered during an internet search.
Fourth button—opens a utility program such as Windows° Calculator program to make it easy for the user to perform simple calculations and transfer the results to other applications.

Right clicking the third or fourth control button displays a list of the operating system's most popular accessory programs such as Window's: Backup, Phone Dialer, CD Player, Windows Media Player, Fax, Paint, Freecell, Solitaire, Minesweeper, Pinball, etc. By selecting a program, the user assigns it to one of these control buttons. The first and second control buttons are hard coded and are not user-modifiable. Assignments for the third or fourth control buttons can at the “sponsor's” option, be hard-coded to control actions related to the Content Carousel, such as printing coupons, rebate forms, entry forms, etc.

Utility Programs

The toolbar places four useful utility programs at the user's fingertips. This convenience saves the user significant time because the programs are immediately available without the user having to first minimize the application he or she is working in and opening the utility programs to access their functionality.
1. Hibernation—When the toolbar is in “always-on-top” mode, a “Hibernation Button” appears in the middle of the toolbar's left border. Clicking it minimizes the toolbar and places a toolbar icon on the operating system taskbar, and if an application is open, resizes it to full screen. When this icon is clicked again, the toolbar reopens and the application, if it is still open, is automatically resized. The Hibernation Button lets the user remove the toolbar from the desktop without closing the program, and then with a single click, restore it. The Hibernation Button does not appear when the toolbar is in “autohide” mode.
2. Volume Control—A sliding control button on the right hand side of the toolbar controls the computer's master volume control. Double clicking the control button mutes the volume; double clicking it again restores the sound to its previous volume level.
3. Clock—A display window, utilizing the system clock function, appears near the bottom of the toolbar. Double clicking the window toggles the display from a 12 to 24 hour format; double clicking it again changes the display back to a 12-hour format.
4. Screensaver—Left-clicking the control button below the clock activates the system's default screensaver. Right-clicking the control button accesses the operating system's shutdown facility.

### Toolbar Management System

The initial toolbar installation also installs the toolbar management system. This system operates as a “sponsor librarian”. It allows a user to have multiple toolbars, each with its own unique configuration, on his or her computer at the same time and, by right-clicking on the first button on the Configuration Dashboard, easily switch between toolbars without having to close the program. At startup, the toolbar management system reopens the most recently used toolbar. The system also controls other program functions such as program security, registrations, transaction processing and remote software maintenance and software updating, etc.

Sponsor Carousel

The toolbar management system is the toolbar operating system that allows a user to have multiple toolbars, each with its own unique configuration, on his or her computer at the same time and easily switch between them without having to close the program. This feat is accomplished by utilizing a file directory system that creates a separate container for each toolbar. These containers include all of the unique operating instructions associated with individual toolbars, including: personality “skins”, URL links, “sponsor”-designated actions assigned to control buttons, “sponsor”-provided digital images, pictures, audio files, forms, captions and streaming text, etc., for the Content Carousel and “sponsor”-provided advertisements and images for the Advertising Carousel. Links stored in the Internet Library's Workspace panel and button and program assignments in the Application Hotel made by the user are stored as a part of the toolbar management system so the user's designated preferences are available irrespective of which toolbar is being used. When the second toolbar is installed, the toolbar management system creates a drop-down menu that lists both toolbars and allows the user to select the desired toolbar. Subsequent toolbar installations update the menu. The maximum number of toolbar installations is a function of the storage available on the system's hard drive. Right-clicking the first control button on the Configuration Dashboard displays the list of installed toolbars. Selecting a “sponsor” and left-clicking, closes the previously open toolbar and opens the selected toolbar.

User Registration

As a part of all toolbar installations, the toolbar management system requests users to complete and submit a registration form via the internet. During the registration process, the toolbar management system checks the registration database to determine if it is an authorized toolbar. If it is, it will be registered in the registration database, the registration information will be posted to the “sponsor's” account, and the toolbar will be installed on the user's computer. If it is not authorized, the user will be notified and the toolbar management system will not register or operate the toolbar.

When installation is complete the registration information will be sent to the “sponsor” organization. The registration database will track the total number and types of toolbars installed, by “sponsor” organization, as well as by version number.

Software Maintenance

During all toolbar installations, the toolbar management system checks to determine if a newer version of the toolbar management system software is available. If a newer version is available, it will, with the user's permission, be installed over the old version.

Routine program maintenance is provided via the internet by means of a periodic check of the version number of each user's toolbar management system program to determine whether it requires updating. If it does, with the user's permission, the most current version will be downloaded and any necessary program updates will be installed. During routine program maintenance the maintenance server will also verify that all installed toolbar license subscriptions are still valid. If any are due to expire within thirty days, the user will be notified that, although the user's other toolbars will continue to operate, those flagged will no longer operate if a toolbar “sponsor” elects not to renew its license.

### Technical Description of the Preferred Embodiment

The invention is embodied in a software program that is installed on a user's internet-enabled computer, which then communicates over the internet with one or more “sponsor” server computers. The invention is also applicable to other network schemes such as WANs and LANs. The preferred embodiment of the invention is described in the context of the Microsoft Windows operating system. However, the invention can be used with any operating system, with appropriate modifications to achieve the described functionality.

Details of the system requirements for the invention, except for the software described herein, are disclosed in part in U.S. Pat. No. 6,819,343, US Patent Application Publication number US 2004/0204988 A1, and US Patent Application Publication number US 2001/0042016 A1, all incorporated herein by reference.

The Picture Carousel (Content Carousel Window, see the Drawing)

The basic function of the picture carousel is to display images supplied by the “sponsors in a rotating order.

The initial software installation will load several images and related text files provided by the “sponsor” onto the user's hard-drive in a particular folder chosen by the user. When an internet connection is not present the contents of this folder are displayed. The program periodically checks whether there is an internet connection. Once there is a connection, the program downloads updated information from the “sponsor” server and keeps the information in the temporary folder. This information is then displayed. Each set of images has a .txt file which contains the title of each image.

The preferred embodiment will have images in jpg format. Naming convention of the images is carouse1.jpg, carousel2.jpg, carousel3jpg, . . . , carouselxjpg. However, the invention can be used with other graphical files, with appropriate modifications to achieve the described functionality.

The Titles must be put in the file named “title.txt” in the following syntax: each title should be in a separate line with the image number followed by TAB and then the title of the picture.

Streaming Message box (Streaming Text Window, see the Drawing)

The contents of the streaming message are in a file called “streamingmsg.txt”. On installation, this file is also installed in the toolbars folder. The messages to be displayed are in a new line beginning with the message number followed by a TAB and then the message. The program reads the messages in numerical order and periodically displays them one by one. In a similar manner as the images, new “streamingmsg.txt” files may be downloaded if there is an Internet connection.

The Internet Library Window (See the Drawing)

Favorites

The Favorites panel is the mirror of the user's Favorites folder. This is implemented by reading the contents of the user's Favorites folder, usually located at “C:\Documents and Settings\User name\Favorites”. The program differentiates between a folder and a link, thereby arranging them a proper way with the help of a dynamic menu. The URL of each link is extracted from the ”.url” files which are placed in the menu.

Search Window (See the Drawing)

The Search Window is integrated to one particular search engine at a time. On installation, several search engines may be added. When a user types in the window and presses the ENTER key, the program reads the text and sends it to the search box of the intended search engine. Users can download new plug-ins to add more search engines.

This is implemented by having a configuration file for all the search engines which contains the URL and the search text for each engine. Icons for the search engines are also included.

Workspace

The Workspace is the user's own assignable link library where one can drag and drop links from any website or from the address bar of the browser itself. Once a user drags and drops a particular link to the toolbar, the program interprets the link's URL and saves it in the Workspace folder located in a shared file on the user's computer, usually located at “C:\Program Files\Common Files\. The user is also given the option to give a user-friendly name to the link. If such a name is not specified, the program takes the URL name as the link's name.

The contents of the Workspace can be deleted by right clicking in the workspace area. This is implemented by displaying the contents of the Workspace folder in a tree view and allowing the user to delete a link or the folder itself.

Toolbars Link

The last section contains the URL assigned to each toolbar “personality module”. Each toolbar contains a file named “settings.cfg”. This file contains the settings of all the “personality modules” available to the toolbar and one of the entries is the URL of the fourth link. The program reads this URL and assigns it to the fourth link, giving it the same name as that of the toolbar.

Application Hotel Window (See the Drawing)

The Application Hotel consists of eight buttons linked to different applications. In the first instance, the program tries to find the default application used to open the most common files, e.g., .txt, .doc, jpg and so on. It tries to find the eight most common applications employed by the particular user. If the user's computer has less than eight application programs, the program will link the remaining buttons to Window utility programs, arbitrarily ranked in order of presumed popularity, such as Windows Media Player, CD Player, Paint, etc.

Later, users can drag and drop shortcuts to an application or a file to the button they desire to associate with the application or file. When the user drags any content onto a button, the program translates the path of the target file for the dropped files, extracts the icon and assigns it to that particular button.

Advertising Carousel Window (See the Drawing)

The initial installation will install a series of “sponsor” images for the Advertising Carousel. Each “sponsor” image could be associated with a URL. If so, it will be in the setting.cgf file. On double clicking the image, the URL is opened in the default browser.

The Advertising Carousel also has the ability to rotate the available sponsor images. Again this characteristic is also set in the “settings.cfg”.

Hibernation Control Button (See the Drawing)

The toolbar is set to “hibernate” when the user clicks on the hibernate button. When the user clicks on the hibernation button, the program un-registers itself as a Windows desktop toolbar and hides itself with an animating effect which shows the toolbar minimizing to the system tray. An icon is placed on the system tray to show the existence of the toolbar, and the user can re-activate the toolbar by double clicking the icon. On double clicking, the icon is removed from the system tray and again with a maximizing effect the toolbar is placed in its old activated position.

Personality and Sponsor Window (See the Drawing)

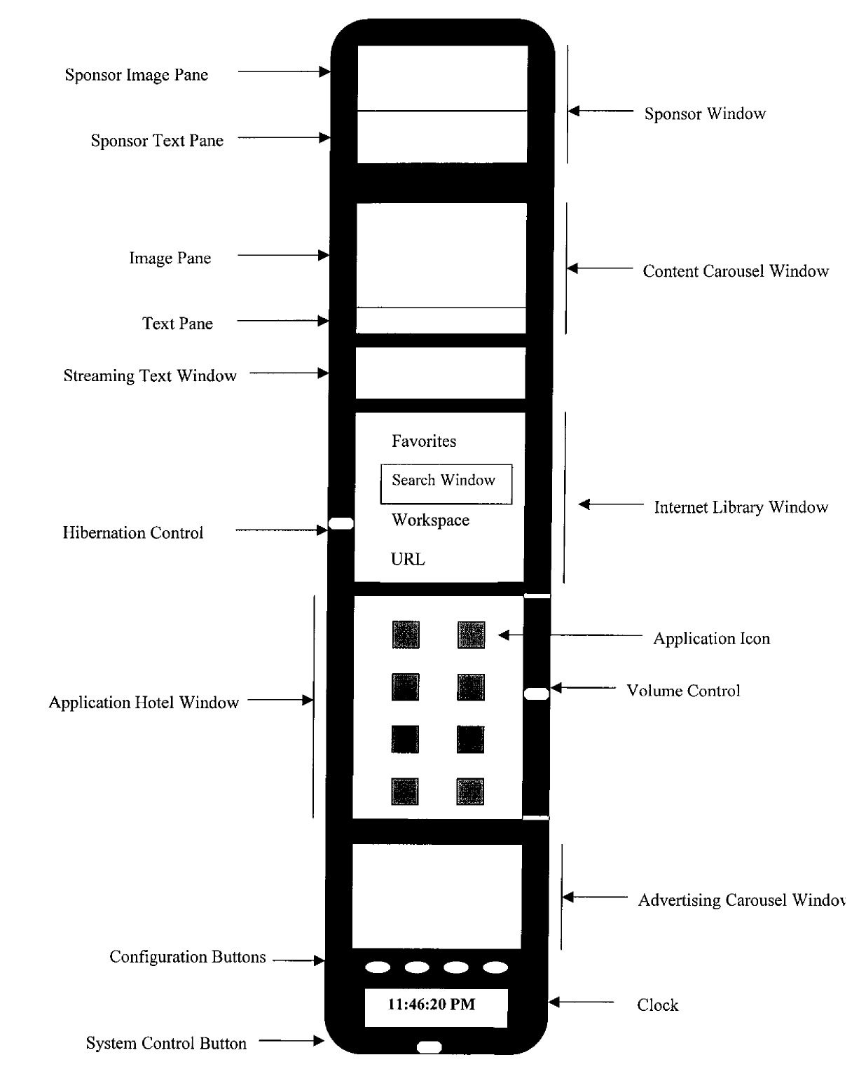

Each toolbar “personality module” has its unique image for its skin (the black areas in FIG. 1), logo (in Sponsor Image Panel), configuration buttons, slider bar and the color codes for the different boxes. The “setting.cfg” file has a list of entries for each “personality module”. According to the entries in this file, the toolbar selects the images for its skin, logo and the image for the Sponsor Image Pane, and the different links and actions to the configuration buttons. There is also a set of URLs from where to download the images for the Sponsor Image Pane carousel. The pictures are displayed in the carousel in a rotating order with a certain periodicity.

Configuration Buttons (See the Drawing)

The third and fourth configuration button can be assigned to a choice of fixed number of behaviors hard coded in the program. The type of behavior is set in the setting.cfg file of the toolbar. According to the type of behavior, on activation of the button the behavior mentioned in the program is executed.

Auto-Hide and Always-on-Top

When in “always on top” mode the toolbar registers itself, with its full width, as a Windows desktop toolbar. When the toolbar is in “always on top” mode with an application open, the application is resized so that it occupies the remaining screen area. When it is in auto-hide mode the toolbar registers with only one pixel width as a Windows desktop toolbar and it slides off to the side. In “autohide”, the toolbar remains hidden until the user moves the cursor over a “hotspot”. When the cursor hits it, the toolbar instantly appears and remains on the screen until the cursor is moved back to the application workspace.

Volume Controller (See the Drawing)

The volume control icon on the toolbar replicates the function of the Windows master volume controller in real time. This is implemented with the help of a bitmapped slider controller that changes the system volume according to the position of the slider control.

If a user changes the volume from the Windows volume control interface, the position of the slider in the toolbar also changes accordingly. This is implemented by trapping the message that is sent by the Windows operating system to all the available processes and translating the current position of the volume using appropriate API.

The specific embodiments set forth above do not limit the scope of the invention, which is defined by the claims. Other embodiments will occur to those skilled in the art and are within the scope of the following claims.

What is claimed is:

1. A method of providing a marketing portal presented in the form of a user and third-party customizable toolbar that is displayable on the desktop of a user's computer, in which the user's computer is electronically coupled to a third-party's computer, the method comprising:
creating on the user's desktop a toolbar that defines a number of separate functional areas, the functional areas comprising at least a third-party content area, an internet library area, a computer applications area, and a toolbar configuration area;
storing in the user's computer a plurality of third-party messages, at least one such message comprising at least an image;
sequentially displaying the third-party messages in the toolbar third-party content area;
providing in the internet library area one or more links to web sites, wherein the user can modify at least one such link;
providing in the computer application area a plurality of links to application programs accessible by the user's computer; and
providing in the toolbar configuration area a plurality of separate function-specific, user-operable buttons, wherein the function associated with at least one such button is fixed, and the function associated with at least one other such button is user-assignable.

2. The method of claim 1 wherein the third party comprises a sponsor.

3. The method of claim 2 wherein the computers are linked over the internet.

4. The method of claim 1 wherein the third party comprises the user's employer.

5. The method of claim 4 wherein the computers are linked by a private network.

6. The method of claim 1 wherein the toolbar further defines a sponsor window.

7. The method of claim 1 wherein the toolbar further defines an advertising carousel window.

8. The method of claim 1 wherein the third-party content area further comprises a streaming text window.

9. The method of claim 8 wherein the stored third-party messages further comprise text associated with the images, the text at least in part displayed in the streaming text window.

10. The method of claim 1 wherein the stored third-party messages further comprise text associated with the images, the text at least in part displayed in the third-party content area.

11. The method of claim 1 wherein the toolbar further defines a user-operable volume control function.

12. The method of claim 1 wherein the toolbar further defines a user-operable control that allows the user to minimize the toolbar.

13. The method of claim 1 wherein the toolbar further defines a toolbar display skin.

14. The method of claim 13 further comprising storing in the user's computer a plurality of different display skins.

15. The method of claim 14 wherein one of the function-specific, user-operable buttons in the toolbar configuration area provides user control over the displayed toolbar skin.

16. A method of providing a marketing portal presented in the form of a user and third-party customizable toolbar that is displayable on the desktop of a user's computer, in which the user's computer is electronically coupled to a third-party's computer, the method comprising:
creating on the user's desktop a toolbar that defines a number of separate functional areas, the functional areas comprising at least a third-party content area, an internet library area, a computer applications area, an advertising carousel window, a toolbar configuration area and one or more toolbar display skins;
storing in the user's computer a plurality of third-party messages, at least one such message comprising an image and text associated with the image;
sequentially displaying the third-party messages in the toolbar third-party content area;
providing in the internet library area one or more links to web sites, wherein the user can modify at least one such link;
providing in the computer application area a plurality of links to application programs accessible by the user's computer; and
providing in the toolbar configuration area a plurality of separate function-specific, user-operable buttons, wherein the function associated with at least one such button is fixed, and the function associated with at least one other such button is user-assignable.

17. A method of providing a marketing portal presented in the form of a user and third-party customizable toolbar that is displayable on the desktop of a user's computer, in which the user's computer is electronically coupled to a third-party's computer, the method comprising.
creating on the user's desktop a toolbar that defines a number of separate functional areas, the functional areas comprising at least a third-party content area, an internet library area, a computer applications area, a toolbar configuration area, and a toolbar display skin;
storing in the user's computer a plurality of third-party messages, at least one such message comprising at least an image, and also storing a plurality of different toolbar display skins;
sequentially displaying the third-party messages in the toolbar third-party content area;
providing in the internet library area one or more links to web sites, wherein the user can modify at least one such link;
providing in the computer application area a plurality of links to application programs accessible by the user's computer; and
providing in the toolbar configuration area a plurality of separate function-specific, user-operable buttons, wherein the function associated with at least one such button is fixed, and the function associated with at least one other such button is user-assignable, wherein one of the function-specific, user-operable buttons in the toolbar configuration area provides user control over the displayed toolbar skin.
